(19) United States
(12) Patent Application Publication
(10) Pub. No.: US 2004/0153440 A1
(43) Pub. Date: Aug. 5, 2004

(54) Unified management of queries in a multi-platform distributed environment

(76) Inventors: Assaf Halevy, Lachish (IL); Boris Giterman, Beer Sheva (IL)

Correspondence Address: NATH & ASSOCIATES PLLC, 6th Floor, 1030 15th Street, NW, Washington, DC, 20005, US

(21) Appl. No.: 10/354,149

(22) Filed: Jan. 30, 2003

(51) Int. Cl. G06F 17/30; G06F 7/00

(52) U.S. Cl. 707/3

(57) ABSTRACT

A system for a unified management of queries in a distributed environment that includes plurality of nodes interconnected through a communication network. A query initiating node which can be a query processing node being configured to receive or place a query in respect one or more subjects. The query processing node includes a processor and communication and is associated with a database having given characteristics. The database stores information on subjects. The node is further associated with demographic index and query catalog. The processor and communication being configured to perform the following, including: placing or receiving a query in respect of one or more subjects, accessing the demographic index and query catalog for determining a remote node in the network, if any, such that the database of each one of the nodes stores information on the subjects and determining a query format that meets the respective data characteristics of the database of each node. The processor is further configured to transmit the query, through the communication network, to each one of the remote nodes and receiving the query result from the remote nodes in an asynchronous fashion. The processor is further configured to merge the query results received from the selected node into a complete merged query result and displaying the complete query result.

### FIELD OF THE INVENTION

The invention is in the general field of unified management of queries in a multi-platform distributed environment.

### BACKGROUND OF THE INVENTION

One of the main issues of enterprise is sharing and delivering information between its different parts. The need to make data available in such distributed systems and the need for different levels of exposure to different levels of personnel is becoming a problem when highly complex systems are concerned.

Consider, for example, a Medical Health Care organization. A typical structure of such an enterprise will be several hospitals, regional care centers, clinics, physicians, and several levels of managers in different administrative departments throughout the enterprise.

Various types of information, clinical, financial etc., must be distributed throughout the enterprise without breaking security levels or confidentiality, which are highly essential in such subjects. In addition, users throughout the enterprise want to see integrated information collected from several resources, however, different data sources may use different platforms, data types and structures and integration is a complicated task. In addition, the different resources should be kept transparent and the information should be available for different kinds of processing procedures. Those procedures are usually implemented by independent applications throughout the enterprise using information from several levels and aspects according to the relevant subjects.

Related art include the following publications:

| Publication | Inventor |
|---|---|
| U.S. Pat. No. 5,701,451 | Rogers et al. |
| U.S. Pat. No. 5,761,663 | Lagarde et al. |
| U.S. Pat. No. 5,899,997 | Ellacott et al. |
| U.S. Pat. No. 6,035,324 | Chang et al. |
| U.S. Pat. No. 6,070,184 | Blount et al. |
| U.S. Pat. No. 6,085,186 | Christianson et al. |
| U.S. Pat. No. 6,102,969 | Christianson et al. |
| U.S. Pat. No. 6,157,941 | Verkler et. al. |
| U.S. Pat. No. 5,774,668 | Choquier et al. |
| U.S. Pat. No. 6,185,619 | Joffe et al. |
| U.S. Pat. No. 6,058,394 | Bakow et al. |
| U.S. Pat. No. 5,802,292 | Mogul |
| U.S. Pat. No. 5,925,100 | Drewry et al. |
| U.S. Pat. No. 6,263,330 | Bessette |
| U.S. Pat. No. 6,278,999 | Knapp |
| WO 98/56132 | Pal, Shankar |
| WO 00/77637 | Young, Bruce A. |
| WO 97/46939 | Piskiel, Harold, Aron |
| GB 2326000A | Andrew John Bainbridge et al. |
| EP 600235A | Peter Page |

### SUMMARY OF THE INVENTION

The invention provides for a method for a unified management of queries in a distributed environment that includes plurality of nodes interconnected through a communication network, each node is associated with a database that stores information on subjects; the method comprising:

i) in a query initiating node, placing a query in respect of at least one subject;

ii) applying load balancing for determining at least one query processing node, and in the case that a query processing node being different node than the query initiating node, transmitting the query to the query processing node;

iii) determining in the query processing node at least one remote node in the network, if any, such that the database of each one of said remote nodes stores information on at least one of said subjects, and transmitting the query, through said communication network, to said remote nodes;

iv) each one of the remote nodes processing the query, giving rise to respective query results and transmitting the query results to said query processing node;

v) the query processing node merging the query results received from said remote nodes into a complete merged query result; and

vi) displaying at least part of said complete query result.

The invention further provides for a system for a unified management of queries in a distributed environment that includes plurality of nodes interconnected through a communication network;

a query initiating node configured to receive or place a query in respect of at least one subject; the query initiating node includes processor and communication and is associated with a database having given characteristics; the database stores information on subjects; the node is further associated with demographic index and query catalog; the processor is configured to perform load balancing for determining at least one query processing node, and in the case that a query processing node being different node than the query initiating node, transmitting the query to the query processing node;

the query processing node includes processor and communication and is associated with a database having given characteristics; the database stores information on subjects; the node is further associated with demographic index and query catalog,

the processor and communication being configured to perform the following, including:

placing or receiving a query in respect of at least one subject;

accessing said demographic index and query catalog for determining at least one remote node in the network, if any, such that the database of each one of said nodes stores information on at least one of said subjects and determining a query format that meets the respective data characteristics of the database of each node;

transmitting the query, through said communication network, to each one of the at least one remote nodes;

receiving the query result from said at least one remote nodes in an asynchronous fashion;

merging the query results received from said selected node into a complete merged query result; and

displaying at least part of said complete query result.

Yet further, the invention provides for a method for a unified management of queries in a distributed environment that includes plurality of nodes interconnected through a communication network, each node is associated with a database that stores information on subjects; the method comprising:

i) receiving an occurring event;

ii) analyzing the occurring event and determining information that needs to be pre-fetched, and in response firing a triggering event;

iii) placing a pre-fetch query in respect of at least one subject;

iv) determining at least one remote node in the network, if any, such that the database of each one of said remote nodes stores information on at least one of said subjects, and transmitting the query, through said communication network, to said remote nodes;

v) each one of the remote nodes processing the query, giving rise to respective pre-fetched query results and transmitting the query results to said query processing node;

vi) merging the pre-fetched query results received from said remote nodes into a complete merged query result; and

vii) displaying at least part of said complete pre-fetched query result.

The invention provides for a system for a unified management of queries in a distributed environment that includes plurality of nodes interconnected through a communication network;

a node includes processor, communication and associated database having given characteristics; the database stores information on subjects; the database includes demographic index and query catalog;

the processor and communication and associated database being configured to perform the following, including:

receiving an occurring event, analyzing the occurring event and determining information that needs to be pre-fetched, and in response firing a triggering event;

placing a pre-fetch query in respect of at least one subject;

accessing said demographic index and query catalog for determining at least one remote node in the network, if any, such that the database of each one of said nodes stores information on at least one of said subjects and determining a query format of said pre-fetch query that meets the respective data characteristics of the database of each node;

transmitting the query, through said communication network, to said remote nodes;

receiving pre-fetched query result from said at least one remote nodes in an asynchronous fashion;

merging the pre-fetched query results received from said selected node into a complete merged query result; and

displaying at least part of said complete pre-fetched query result.

### BRIEF DESCRIPTION OF THE DRAWINGS

For a better understanding, the invention will now be described, by way of example only, with reference to the accompanying drawings, in which:

FIG. 1 illustrates a generalized system architecture for clinical information retrieval application in accordance with an embodiment of the invention;

FIG. 2 illustrates schematically the structure of the various system components in accordance with one embodiment of the invention; and

FIG. 3. illustrates a generalized flow diagram of the operational steps of the system in accordance with one embodiment of the invention;

FIG. 4 illustrates an exemplary XML code defining a query catalog, in accordance with one embodiment of the invention; and

FIG. 5 illustrates a generalized procedure for propagating a new query, in accordance with one embodiment of the invention.

FIG. 6 illustrates schematically a load balancing procedure in accordance with an embodiment of the invention;

FIG. 7 illustrates a detailed block diagram of an application balancing module in accordance with one embodiment of the invention;

FIG. 8 illustrates an example form of storing performance statistics, in accordance with an embodiment of the invention;

FIG. 9 illustrates a block diagram of a performance evaluation module in accordance with one embodiment of the invention;

FIG. 10 illustrates a general block diagram of a pre-fetch procedure, in accordance with one embodiment of the invention; and

FIG. 11 illustrates a flow diagram of a pre-fetch architecture and pertinent procedure in accordance with one embodiment of the invention.

### DETAILED DESCRIPTION OF THE INVENTION

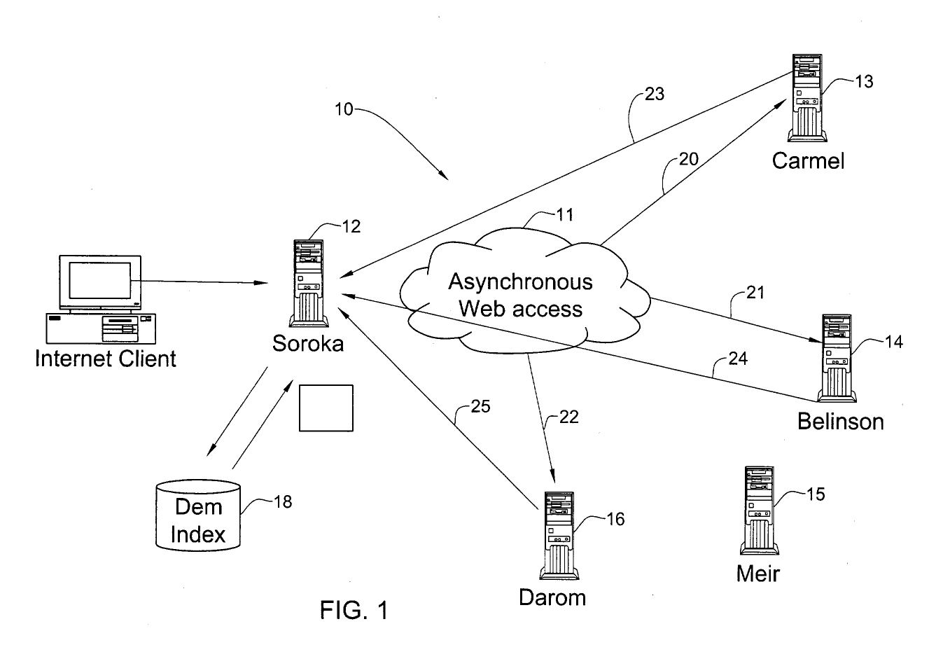

Attention is first directed to FIG. 1, illustrating a generalized system architecture for clinical information retrieval application in accordance with one embodiment of the invention. The invention is, of course, not bound by this application. The system (10) includes a plurality of nodes interconnected through a communication network (e.g. the Internet 11) of which only nodes 12 to 16 are shown. The nodes are placed at remote geographical locations, say in different hospitals. By this embodiment, each node is associated with a demographic index that stores, inter alia, information that pertains to a pre-defined list of queries including an indication on those (other) nodes that include data that may meet the respective query. In the specific scenario of clinical information application, it is often the case that information about particular subject or subjects (in this case clinical information about patients) is found in more than one hospital and it is therefore highly desired to accumulate the relevant information that pertain to this particular patient from all the hospital databases that store data for this patient. This will assist the querying entity (say the physician or the surgeon who treats the patient) to accumulate all the necessary clinical data for this patient and consequently to decide on the appropriate medical procedure. To this end, the demographic index in each node (being one out of many possible implementation variants) will a priori store information including identification of other nodes whose respective databases store relevant information for the query under consideration.

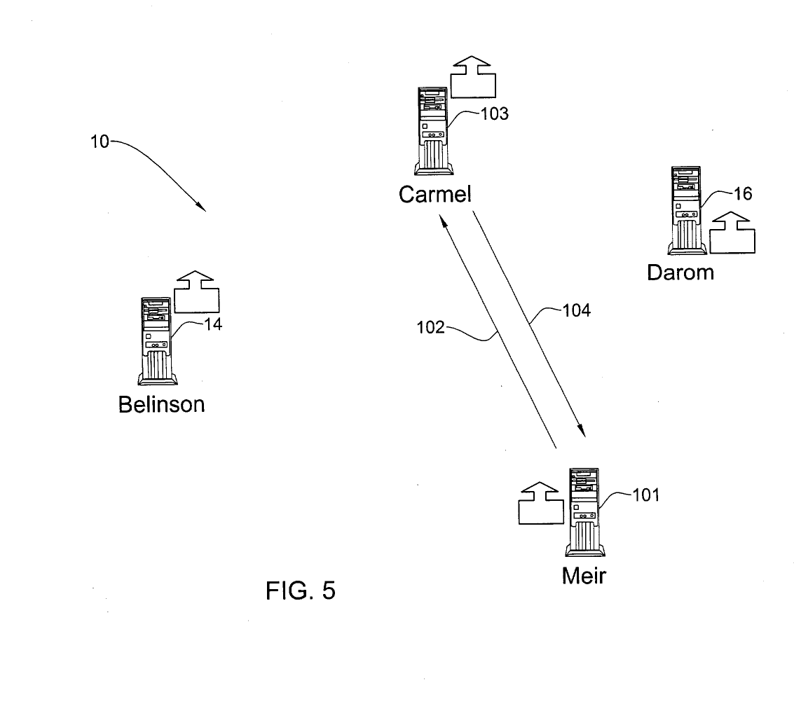

Briefly speaking, when an originating node, say (12), issues a query, the demographic index associated therewith (18) is accessed in order to ascertain whether other nodes should be accessed. In the case that there is no relevant data in other nodes, the query is processed locally. Otherwise, (parallel to the local processing) the query is transmitted through the communication network (11) to the remote node or nodes for processing. Note that when a query is generated at a user node (say in the local PC at the Family physician's clinic) this does not necessarily entail that the latter node (designated the query initiating node) or node associated therewith (say, the nearest hospital node) will “process” the query. By “process” it is meant the query initiating node uses its demographic index to decide whether to process the query locally and/or use other remote nodes, as discussed above with reference to FIG. 1. Thus, in certain scenarios it may be prudent to assign the “processing” of the query from the query initiating node to other node(s) if certain conditions are met. For example, it may well be the case that the query initiating node is currently heavily loaded (e.g. by processing other tasks) compared to other node, or by way of another example the other node a prioiri includes most of the data sought by the query compared to the query initiating node. By this simplified example, it would be advantageous to assign the processing to the other node, rendering the latter as the query processing node. The analysis and decision which node is the adequate query processing node is determined using a load balancing procedure that will be discussed in greater detail below, with reference to FIGS. 6 to 9. For convenience of description only, the description with reference to FIGS. 1 to 5 assumes that the query initiating node is also the query processing node (e.g. 12 in FIG. 1).

Bearing this in mind, attention is drawn again to the example of FIG. 1, where the demographic index indicates that relevant data for the query can be found in nodes (13,14 and 16). The asynchronous transmissions of the query to nodes 13,14 and 16 through the Internet is indicated schematically by arrows 20 to 22, respectively. In accordance with this embodiment of the invention, the query processing node (referred to also as originating node (12)) is not compelled to wait until the query is processed and results are obtained from all the receiving nodes, but rather, upon transmission of the query, the originating node can address different tasks. The receiving node will transmit acknowledgment upon receipt of the query for processing (23, 24 and 25 respectively) thereby informing the originating node that the query is pending for processing. By this embodiment, each of the receiving node will process the pending query in an asynchronous manner under the control of its respective scheduler. Thus, for example, in the case of many tasks and/or tasks which require heavy processing resources, the pending query may be delayed until actually scheduled for processing. This approach constitutes an advantage over applications where the originating node operates in a synchronous fashion and maintains communication with the addressee node(s) until receiving a reply. Note, that in the synchronous mode of operation the synchronous process will normally halt, or be timed out, if the node (or nodes) is (are) down.

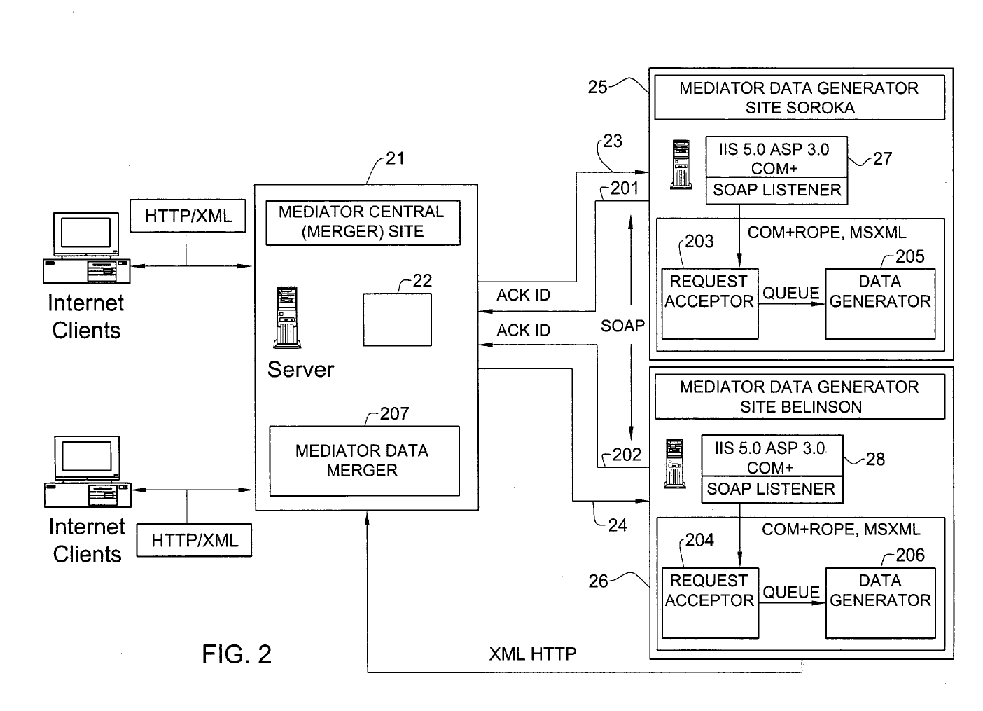

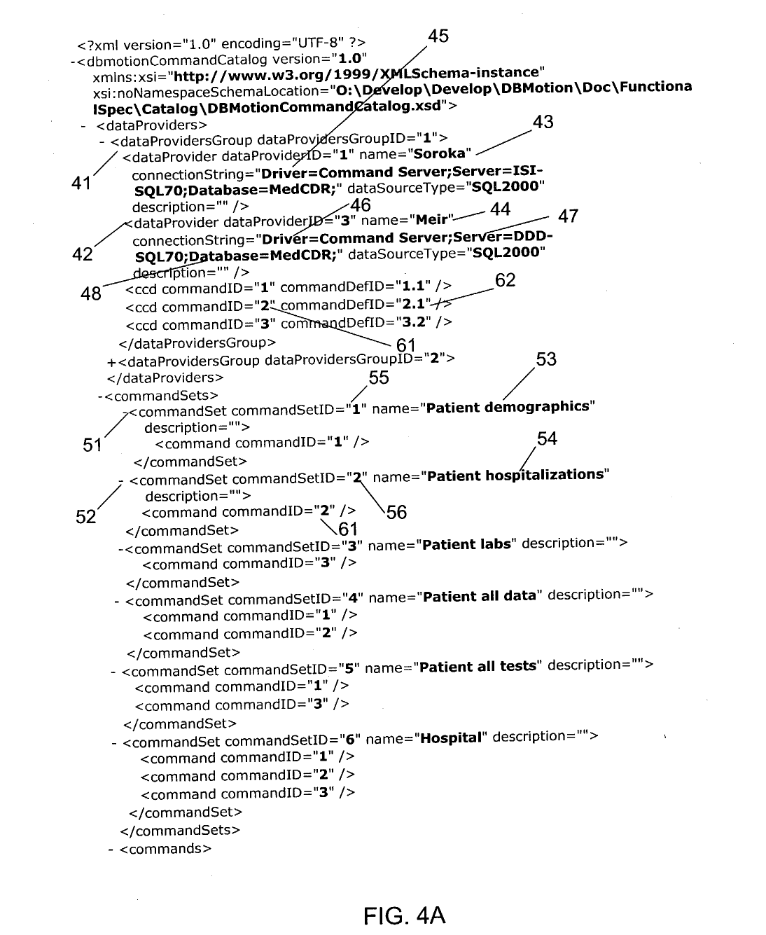

Considering that the queries are a priori known, by one embodiment it is not required to transmit the entire query through the network but rather only the unique query id as extracted from the query catalogue (not shown in FIG. 2 and will be explained in greater detail with reference to FIG. 4) and possibly some additional parameters. Thus, for example, if there is a pre-defined query concerning “extracting the names of the patients that suffer from a certain disease during a given period”, there is a need to transmit the query unique id and the following additional parameters: identification code of the disease and the specified period of time. Hence, the query catalog identified the queries that are supported by the system.

The demographic index (18), in its turn, identifies the nodes that can process the query (i.e. having data that correspond to the query) and the query is transmitted to them for processing. The demographic index preferably distinguishes between sub queries. Thus, for example, a query with a first set of parameters (referred to as a first sub-query) may have corresponding reply data in a first set of remote nodes. For the same query (with different parameters—referred herein as a second sub-query) the reply resides in another (possibly partly overlapping) set of nodes. In the latter example, the demographic index should, preferably, identify the first set of addressee nodes (for the first sub-query) and the second set of addressee nodes (for the second sub-query). This may be implemented, e.g. by storing in the demographic index sub-topics for each query (identifying thus different sub-queries) with an identification of the corresponding set of addressee nodes that store reply for each respective sub query. Consider, for example, a query that concerns retrieval of the Xray Lab results for patient having ID xxx. This would result in identifying in the demographic index a given set of remote nodes that store the requested information. In the case of slightly different sub query, say, retrieval of the Blood Lab results for the same patient (having ID xxx), this may result in different set of remote nodes that store the information. By this specific example the sub-topics are Xray Lab tests, Blood Lab tests and the ID of the patient. Note that the demographic index preferably supports operations that include application of logical operators to the specified topics, say, for example: retrieve remote nodes that store data of Xray Lab results AND Blood Lab results for Patient having ID xxx OR patient having ID yyy (By this example use of AND and OR operators). The demographic index can support different types of topics and operators, all as required and appropriate. The actual implementation of demographic index with the specified characteristics is generally known per se and therefore will not be expounded upon herein.

As noted above, the query id is transmitted over the network and the addressee node (say, for example 14 in FIG. 1) when processing the query (in an asynchronous fashion) will decode the query unique id code and derive the actual query (using, to this end, its respective query catalogue—not shown in FIG. 1) for processing.

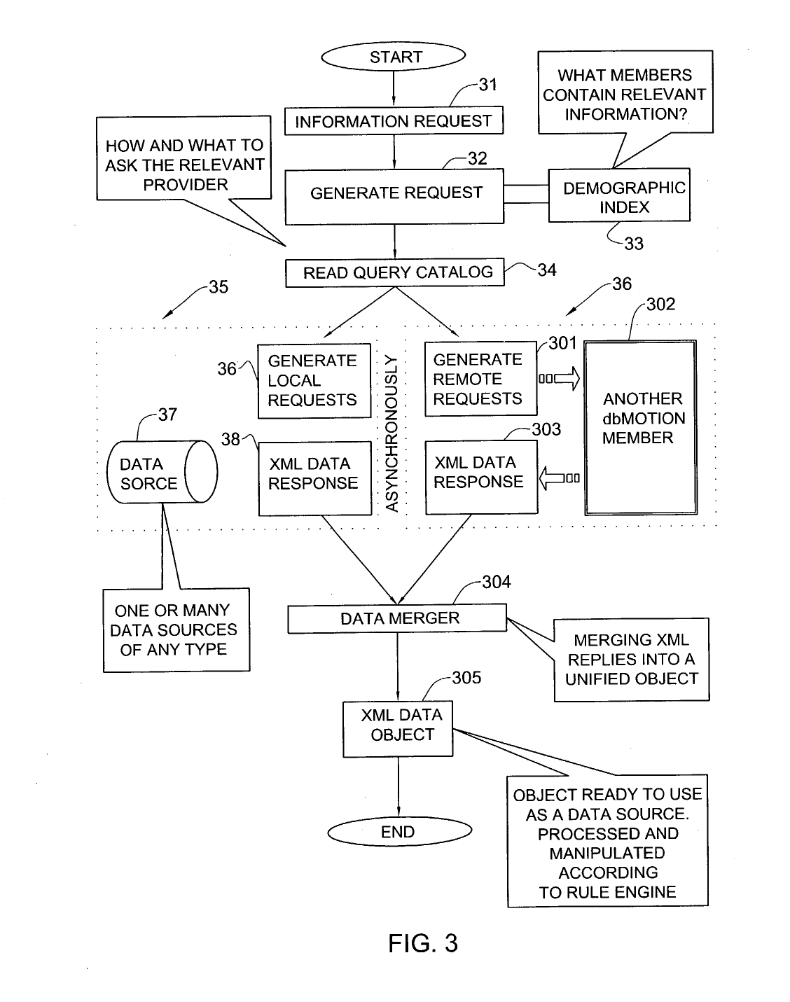

Attention is now drawn to FIG. 2 showing, schematically, the structure of the various system components in accordance with one embodiment of the invention and to FIG. 3 illustrating a generalized flow diagram of the operational steps of the system in accordance with an embodiment of the invention. Thus, the originating node (21) (referred to also as query processing node) receives a request (31 in FIG. 3) from an Intranet node (say, a client in the local area network in the originating hospital). Note that the query processing node is determined after applying the load balancing procedure of the invention.

The originating node needs to prepare a request (32) (22 in FIG. 2) and process the query locally and/or at the remote node. To this end, the demographic index is accessed (33) (18 in FIG. 1) in order to ascertain the nodes which include relevant data and which should be addressed with this particular query). Having determined the recipients, a query catalog is accessed (34—see discussion below) in order to extract the unique query id (and possibly additional parameters) that are required to process the query.

Depending on whether there are relevant remote nodes (as extracted the demographic index (33)), a local processing procedure (35) and/or remote processing procedure (36) commences. For the local processing, local request is generated and applied to local data sources (37) and a reply is obtained. By one embodiment the reply is formed in a semi-structured format (e.g. XML) and submitted as a response (38). In the case of remote processing procedure, the query id and the pertinent parameters are transmitted (over the communication network) to the selected nodes (as extracted from the demographic database), see 23 and 24 transmitted to selected nodes 25 and 26 respectively, and steps 37 and 38 in FIG. 3.

The query data (i.e. the query id and the pertinent parameters) is received through, e.g. Simple Object Access Protocol (SOAP-27 and 28), which is a known per se communication protocol, and the query data are fed to respective Request Acceptor module (203 and 204). The query data are then placed in queue (205 and 206) and processed in an asynchronous fashion in Data Generator module (207 and 208, respectively).

By this embodiment, due to the asynchronous fashion in which the queries are processed at the receiving node, an immediate acknowledgement is, preferably (although not necessarily), transmitted back (201, 202) indicating to the originating node that the query is received (but not as yet processed). Note that by other embodiments acknowledgement is not required.

Whilst this is not shown in FIG. 3, there are further provided known per se error handling procedures, e.g. for the case that the acknowledgement signal is not sent or not received. Having received the acknowledgement message, the originating node can address different tasks obviating the need to handle resource consuming follow-up procedures that would be required had a synchronous mode of operation been used. Each node (in the particular example of FIG. 2, 25 or 26) processes the query in an asynchronous fashion using the Data Generator component (207 and 208). The collection of the query results and the construction thereof are, by one embodiment, in semi-structured form (e.g. XML format) and are implemented in data generator module (207 and 208, respectively—see also 38 and 303 in FIG. 3). The query results are then transmitted to the originating node preferably in a compressed form, using e.g. a binary stream compressing format over TCP/IP. The use of compressed format enables to transmit in an efficient manner large volumes of data (including but not limited to images) and thereby obtain qualitative results which will assist the user (by this particular example the inquiring physician) to decide on the appropriate medical treatment.

The information received at the originating node is decompressed and processed in data merger module (207) (304 in FIG. 3), and delivered to the querying user (or application)(305). Due to the asynchronous nature of the processing, the results are delivered at different terms and there is a need to merge the results to the already available results (at the originating node). In the case of XML, merging distinct XML files is a known per se procedure that will not be expounded upon herein. The same applies to the known per se procedure for converting query results to an XML form. The XML data object further manipulates the so received reply (or replies) for optimizing the transmission process. The transmission is done preferably in chunks of xyz KBytes so large responses will pass in a faster and compact manner, all as known pre se.

The results that are received asynchronously may be presented to the user in any desired manner. Thus, by way of non limiting example, the first received reply is displayed immediately upon receipt and processing and the later arriving results (after being merged) are also presented instantaneously, provided however that they are received within a pre-defined time frame following the receipt of the first answer. All the answers that are received after the elapse of the specified time frame (hereinafter late replies) are duly merged and the user is prompted to know that there is (are) a pending reply. Upon activating the prompt by the user, the pending replies are also displayed. Other variants for displaying the results are, of course, applicable all as required and appropriate. It should be noted that due to the near real-time nature of the processing in accordance with this embodiment of the invention, the specified time frame between transmission of query and receipt of replies from the nodes is typically only few seconds. The replies that will be received in late (due to the delayed processing at the respective addressee nodes) will, preferably, be subject to processing in the originating node as explained with reference to one embodiment above.

By one embodiment, there is an indication of the status of each remote request, an indication whether the members are active (and not has yet provided reply) or have already delivered an answer or are down. Thus, for example, in the case that a given node is not transmitting acknowledgment within a pre-defined time interval, a timeout error indication is set (in respect of the specified node) indicating to the originating node that the specified addressee node is down. Known per se recovery algorithms may be utilized, all as required and appropriate.

Reverting now to the query catalog, attention is directed to FIG. 4 illustrating an exemplary XML code defining a query catalog, in accordance with one embodiment of the invention. The query catalog generally stores information that pertain to queries and (similar to the demographic index) is stored in each node. This, however, is not obligatory and other architectures for storing the query catalog and or demographic index are applicable. Note that the query catalog and demographic index are shown and described as two distinct modules. This, however, is not obligatory and any known per se arrangement thereof is applicable, all as required and appropriate.

As shown in FIG. 4, the query catalog includes Meta-tags e.g. Data Provider (41 and 42) that included contents directed to various hospitals, say Hospital1 and Hospital2 standing each for a remote node (shown in FIG. 1). The database catalog stores in respect of each node the technical details identifying its respective database and possibly other specific technical details. Thus, for example, for Hospital2 (44) the following specific details are provided: driver, server and database (46, 47 and 48, respectively).

Turning now to the Commands Set Meta tags, they elaborate the available queries and their respective ID. Thus, for example, Command Sets (51) and (52) concern Patient Demographic (53) and Patient Hospitalization (54) queries having query ID (CommandSetID) “1” (55) and “2” (56), respectively. Insofar as, e.g. the Patient Hospitalization query is concerned, the Command Meta tag (57) specifies in the parameter Meta tag the specific fields that constitute the query, say Clinic code, and Doctor code (58 and 59, respectively). As further shown in FIG. 4, under the CommandDefs Meta tag (60), the query syntax is provided for each query in respect of a specific database characteristics. Thus, for example, for the Patient Hospitalization query (54) it is associated with CommandID tag having value “2” (61) and associated CommandDefID Meta Tag having value “2.1” (62). The value 2.1 of CommandDefID identifies the precise syntax (63) of the query in the SQL language. Put differently, the query catalog provides the syntax (63) of the query Patient Hospitalization (54) for the particular Hospitsal2 (44) (which as recalled has specific database characteristics as specified by its driver, server and database (46, 47 and 48, respectively) characteristics).

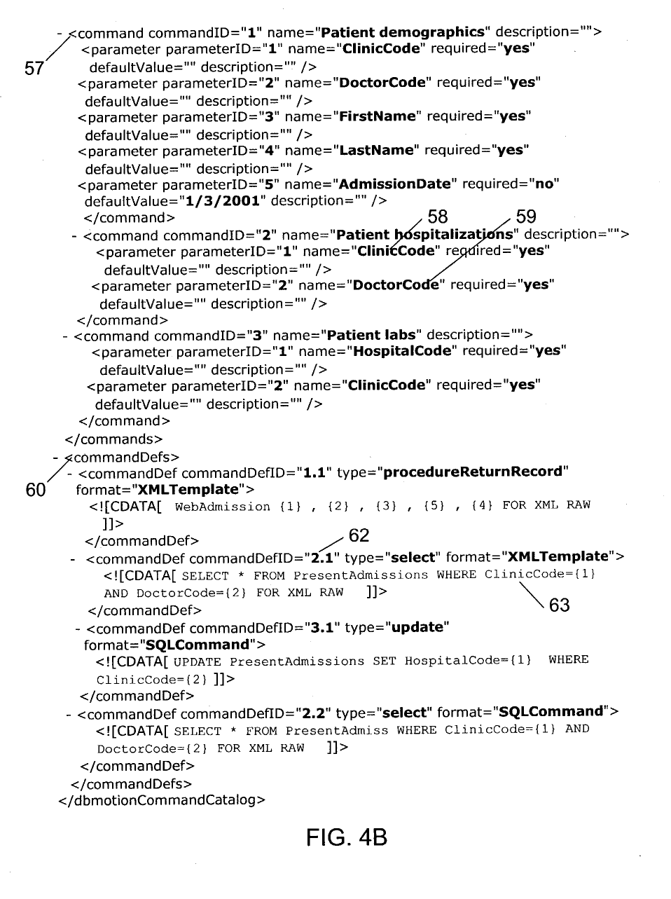

The query catalog of this kind has various advantages. For one, it can be propagated either partially or in its entirety to the remote nodes (as will be explained in greater detail with reference to FIG. 5) in particular when new queries should be transmitted to other nodes. Moreover, it provides a unified transparent mechanism (insofar as the user is concerned) for querying databases irrespective of their structure. Thus, as exemplified above, the Patient Hospitalization query syntax is constructed in accordance with the specific structure of the database in Hospital2. The same Patient Hospitalization query may be constructed in a different syntax in the case that the database characteristics are different. Those versed in the art will readily appreciate that the invention is not bound by neither the catalog architecture of FIG. 4, nor by its contents, which may vary, depending upon the particular application.

The system further employs known per se security modules, e.g. in order to assure that only authorized users will be able to access the data in accordance with their pre-defined permission level.

In the case that a need for a new query arises, the query catalogue and the demographic index are duly updated and the new query (with its unique id) is propagated through the network to the various nodes. For a better understanding of the foregoing, attention is directed to FIG. 5 illustrating a generalized procedure for propagating a new query, in accordance with one embodiment of the invention. Thus, consider a scenario where a need arises to issue a new query in a given hospital. When accessing the local query catalog the query data is not found and naturally there is no need to access the demographic index and ascertain in what remote nodes (if any) should be accessed for this particular query. According to one embodiment the local query catalog is updated with the relevant data that pertains to the new query and this information is propagated to the remote nodes for updating their respective query catalogs. As readily shown in FIG. 5, in the case that a receiving node (say Meir hospital 101) is unable to locate the new query data in its local query catalog, it issues a Teach me query (102) which, when received by the originating node (say Carmel hospital 103) will give rise to an update catalog procedure (104) in which the part of the catalog that includes the information pertaining to the new query is transmitted over the communication network to the receiving node (101) and the latter updates the catalog at its end. In accordance with a modified embodiment, the entire updated catalog (which naturally includes the information of the new query) is transmitted and replaces the existing catalog at the receiving side.

The invention is not bound by these specific scenarios of propagating information for new queries.

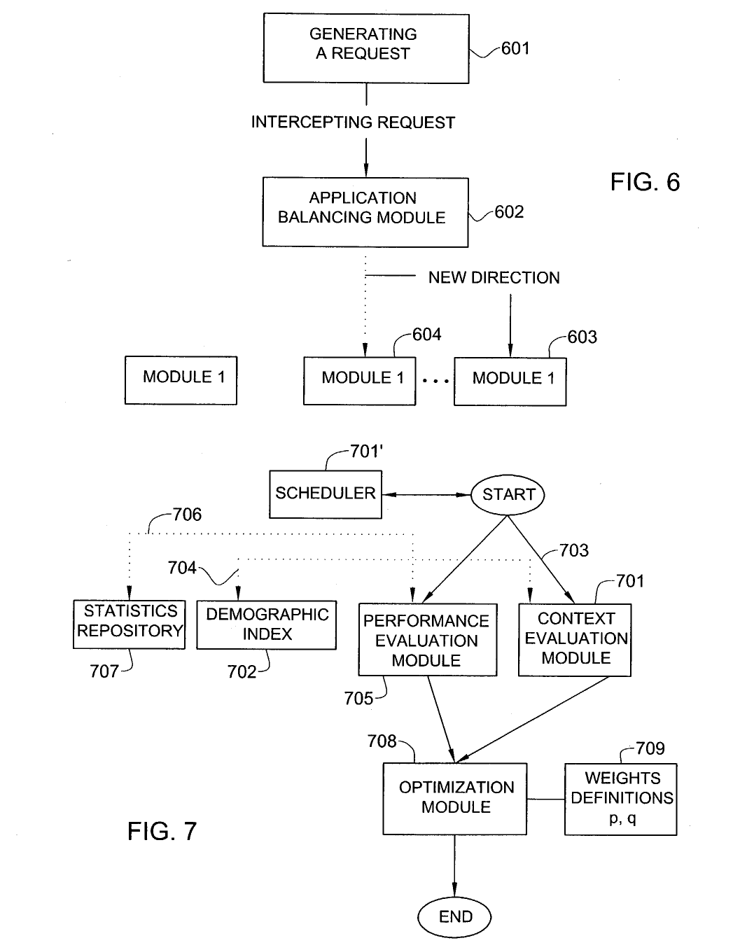

As may be recalled, when a query is issued (referred to also as request is generated, say 32 of FIG. 3), the originating node (query processing node) processes it and by utilizing its associated demographic index (33) and the relevant remote nodes (if any) are addressed in order to obtain sought data stored in their databases. As further mentioned above, a query initiating node is not necessarily the query processing node. FIG. 6 illustrates schematically a generalized load balancing procedure in accordance with an embodiment of the invention, for determining the appropriate query processing node. Thus, when a request 601 (corresponding also to 32 in FIG. 3) is generated (i.e. a query is initiated at a given node) the request is intercepted by application balancing interceptor module (602) that is installed in each node. The balancing interceptor module (602) evaluates which, from among the nodes, is the most appropriate to process the query using criteria that will be discussed in greater detail below, and upon determining the appropriate node, the latter is duly informed and is rendered to be the query processing node. By the example of FIG. 6, node (n) (603) is assigned to be the query processing node rather than the query initiating node (604). Attention is now drawn to FIG. 7, illustrating a more detailed block diagram of an application balancing module in accordance with one embodiment of the invention. By this embodiment only one node is selected to be the query processing node. Thus, By this embodiment, the application balancing module (602) utilizes two sub modules, a first for evaluating context related score of each node and the other for evaluating performance related score of each node. The context score and the performance score are then combined, giving rise to combined score for each node, and the node with the highest score is selected to be the query processing score.

The invention is by no means bound by the specific use of context related score and performance related scores, for application balancing purposes.

Turning now to FIG. 7, context evaluation module (701) is coupled to the demographic index (702) (see also 33 in FIG. 3). The latter, as recalled “knows” the information that is stored in each node. Accordingly, for a given query (request 601 of FIG. 6) that is fed (703) to the context evaluation module (701), the latter (under the control of scheduler module (701′) communicates (704) with the demographic index (702) in order to rank the percentage of the data (sought by the query 601) stored locally in the node. Typically, although not necessarily, the more data stored locally, the higher is the score. Note that high score indicates that significant part of the sought data resides locally in the node, thereby reducing the need to address remote nodes. The parameters that are used to score the context of each node are, by one example, content and time. Content means simply whether the stored data meets the query. For example, if the query seeks blood Lab tests, then this is the content that is of interest (and not, say other Lab test results). The other parameter, time, indicates the relevance of the content. For example, if the sought Lab tests are for the last 3 months, then Lab tests from last year are not relevant. Accordingly, the more the content is relevant and the more the time stamp associated with the stored data meets the time frame of the sought data the higher is the context score for this node.

The invention is by no means bound by the specific embodiment that utilizes content and time parameters for evaluating context score.

Turning now to the performance related score, module (705) communicates (706) with statistics repository (707) which stores relevant data for evaluating performance. The statistics repository stores, by one embodiment the following data: (i) resource related statistics, such as the node's memory and processor availability and/or load at the specified node;

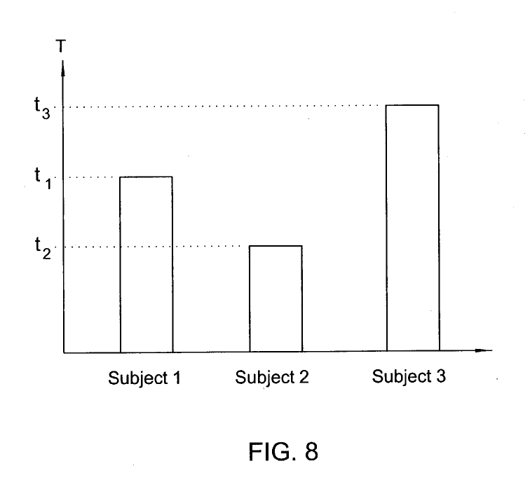

(ii) content interaction statistics, i.e. how many responses per subject per time interval (say minute) were received. This statistics provides indication as to the response time of this particular node for a query in a given subject. Normally, the more responses received within a given time interval for a given subject, the better is “the responsiveness” of the node. These statistics may assist in estimating the response time of each node for a query in a given subject or subjects (on the basis of its response time for past queries in the same subject(s)). Such statistics data may be stored, e.g. in a form of histogram shown in FIG. 8, where for each subject an average response time is indicated. Obviously, the form and manner of representation and the contents thereof, may vary, depending upon the particular application.

(iii) remote-local interactions provides statistics as to the response time in each node for queries processed locally (in the node) vs. queries processed remotely (i.e. by other nodes). These statistics may indicate whether this particular node is more efficient in processing queries locally or remotely.

The invention is of course not bound to the use of the specified criteria of remote vs. local interactions, content interactions and resource availability, and accordingly at least one other criterion can be used instead or in addition to the specified criterion (or criteria).

Note that the raw statistics required to calculate the respective scores (e.g. for remote vs. local grade or content interaction grade) can be accumulated in accordance with one embodiment using Data Tracker tracks all system events: Errors, Jobs, Requests, and Synchronization. If desired, the data tracker may further facilitate system administrators to graphically monitor each request over the system network, and to identify bottlenecks or other problems that would inhibit the system from working at its fullest capacity. By identifying problems in real-time, the Data Tracker enables prompt solutions, thereby increasing the system efficiency.

The invention is not bound by the specified resource, content interactions and local/remote interactions statistics data

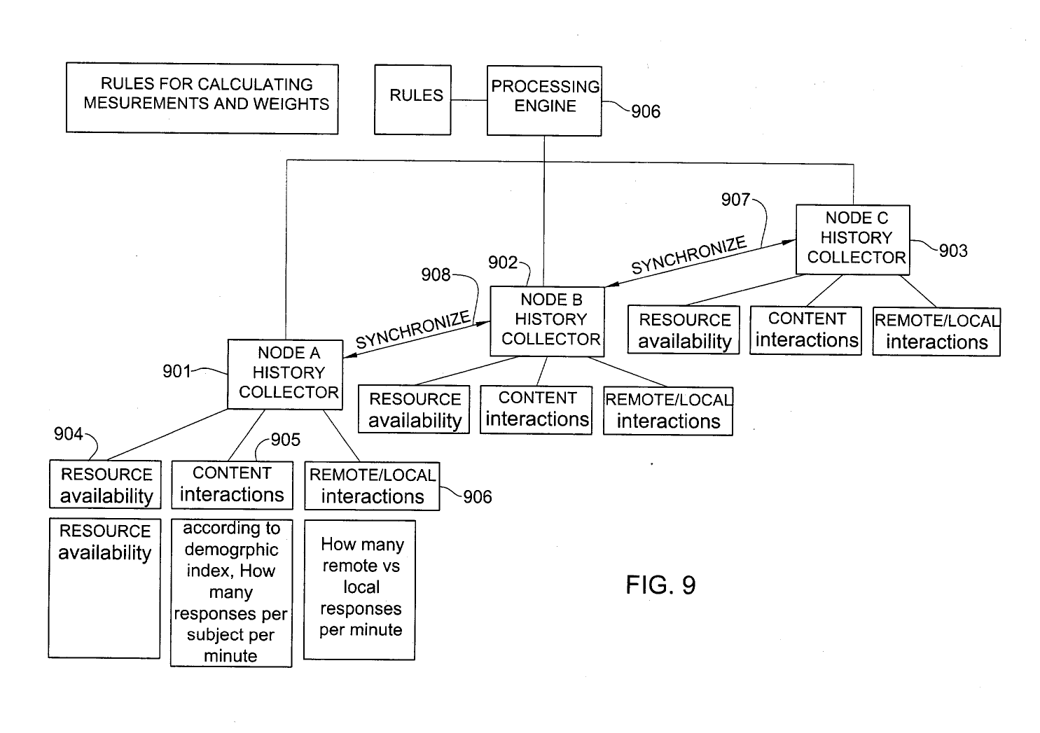

Reverting now to FIG. 7, the performance evaluation module (705) communicates (706) (under the control of scheduler 701′) with the statistics repository (707) for scoring the performance of each node. The operation of the performance evaluation module in accordance with one embodiment of the invention is illustrated in FIG. 9.

As shown each node is fitted with history collector module (say 901 for node A, 902 for node B, 903 for node C, etc.). the history collector of each node accesses the various statistics data modules of its statistics repository (707 of FIG. 7). Thus, for example, in node A module 901 accesses the resource module 904 and obtain a score for resource availability, where by this embodiment the higher the load (i.e. less resources are available) the lower the score. In the same manner it accesses the Content interactions part (905) of the statistical repository (707 of FIG. 7) and ranks the node in accordance with the indicated number of responses per subject per minute. Similarly it accesses the Remote/local interactions part (906) of the statistical repository (707 of FIG. 7) and ranks the node according to the indicated remote vs. local responses. The same procedure is executed for node B (by means of history collector module 902) and for node C (by means of history collector module 903).

To sum up, each node holds through its respective history collector module (in the example of FIG. 9) three different scores for the resource, content interaction and Remote/local interaction data. The evaluation module 705 (of FIG. 7) of a each node is capable of obtaining in addition to its own scores also the three score values of all other nodes (this is obtained through on-going synchronization process between the respective nodes, designating 907 and 908 in FIG. 9) and to evaluate which is the most appropriate node in respect of each score. Thus for example, node A is capable of determining that the best resource score is for node A, the best content interaction score is for node B, etc.) Now, by this embodiment, the distinct results are merged based on variance between the respective scores. For example, if there is a significant variance between the respective resource scores of nodes A, B and C, the resource score will have larger weight in the merged score compared to, say, remote Vs. local score assuming that the latter score is almost identical for all nodes (A, B and C). The rational here is that the more the score can distinguish between the respective nodes the higher weight it receives in the merged result. Thus, in the latter example, the “resource” score (with large variance) is assigned with weight of, say 0.5 and the remote Vs. local score (with small variance) is assignee with weight of, say 0.2. The other (content interaction score) with, say medium variance between the nodes is assigned with weight of, say 0.3. In this manner, the performance evaluation module (705) is capable of determining the most adequate node.

Note that the invention is not bound by the specific sub-scores (resource, content and remote/local) discussed above and not by the manner of obtaining the scores and combining them.

Thus, for example, in accordance with another embodiment, having obtained three scores for each node, a combined score per node is obtained using, say a weighted average calculation (using, for instance, to this end, processing module 908 and its pertinent rule database 909 which prescribes for example the weights associated to each score) and the node having the highest combined score is selected.

Reverting now to FIG. 7, what remains to be done is to combine the context evaluation score of module 701 and the performance evaluation score 702 giving rise to a combined score and this is performed in optimization module 708 using for example a weighted average equation O=Round[(px+qy) div (p+q)], where x is the value obtained from the performance evaluation module 705, y is the value obtained from the context evaluation module 706, and p,q, are coefficients extracted from database 709, or determined in a different Inner, all as required and appropriate. The invention is, of course, not bound by the usage of this equation.

By this specific example, the node with the highest O value is selected to be the query processing nod.

Note that the performance evaluation module operates in an identical manner in each node, and, accordingly all performance evaluation modules (in the respective different nodes) will arrive to the same conclusion, i.e. which is the most adequate node for processing the query, insofar as performance considerations are concerned. By the same token, all context evaluation modules will arrive to the same conclusion, i.e. which is the most adequate node for processing the query, insofar as context considerations are concerned. Accordingly all nodes will arrive to the same conclusion which is the most appropriate query processing node (by combining the results of the context and performance evaluation modules) and in the case that the resulting node is different that the query initiating node, the query will be directed for processing in the resulting node (see, e.g. 605 in FIG. 6).

The query can now be processed in the query processing node in accordance with the manner described with reference to the non-limiting embodiments of FIGS. 1 to 4.

In accordance with another aspect, the invention provided a pre-fetch procedure. The latter procedure “foresees” the need to fetch data to a query processing node from remote node(s) before the data is actually used in the query processing node. Consequently, when the data is actually required by the processing query node it is already available locally and the need to wait until it is fetched from remote node(s) is obviated. Bearing in mind that local processing is, as a rule, more efficient than the alternative of using remote nodes for fetching data, the net effect would be that the query will be processed more efficiently minimizing the response time, insofar as the user is concerned.

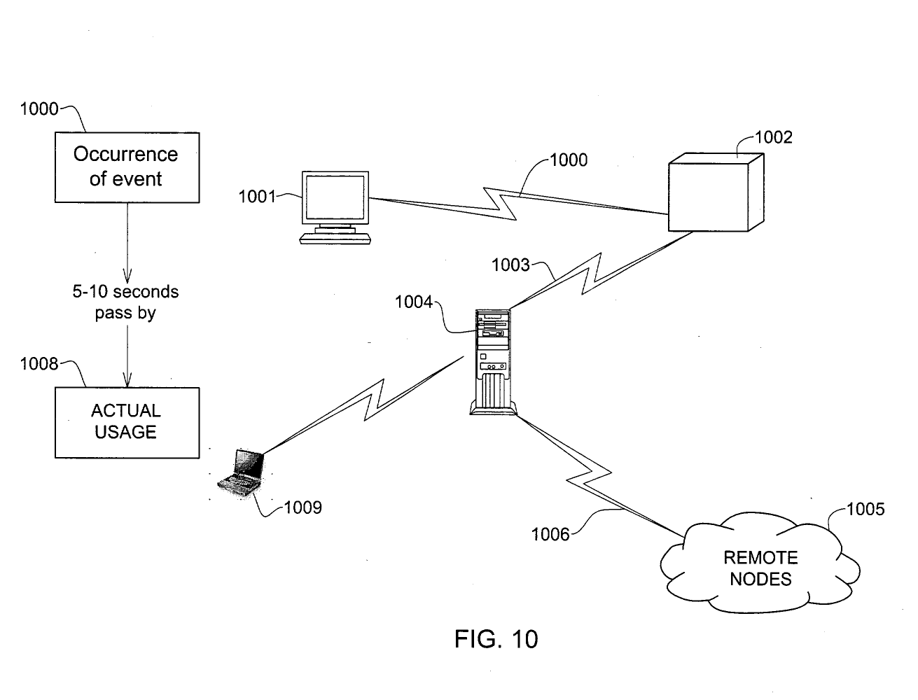

For a better understanding of the foregoing, attention is now directed to FIG. 10, illustrating a general block diagram of a pre-fetch procedure, in accordance with one embodiment of the invention. Thus, when an event occurs (1000), say a patient arrives to the hospital after a car accident, the event is recorded at the input system (1001) and transmitted (1000) to pre-fetch event manager (1002) which communicates with knowledge base to decide which data is required to be pre-fetched. Such data may be, for example, the blood type of the patients, allergy to medicaments, etc.

Having decided what data is required, a triggering event is fired (1003) and an analysis is performed (1004) to determine the remote nodes in which the data resides (using to this end procedures, described above, with reference to FIGS. 1 to 4), and if portion or all of the sought data resides in remote node(s) (1005), the data is fetched from the remote node(s) (1006). Now, when the data is actually required (e.g. when a physician examines the patient at the emergency room 1008), the data is already available at a terminal (1009) accessible to the physician. Note that, normally, certain time (few minutes or more) elapses from the occurrence of the event (say the reception of the patient to the hospital) to the time that the data is actually required (e.g. the examination of the patient by a physician at the emergency room). Due to the pre-fetch procedure there are good prospects that when the data is actually required all or most of it is already available at the local node and readily accessible to the user (in the latter example to the examining physician). The net effect is that the appropriate treatment can be applied to the patient instantaneously, say, by administrating the appropriate medicament (knowing due to the pre-fetches data that the patient is not allergic to the so administered medicament)

Note that without the pre-fetch data, the whole process of analyzing what is the required data, where it resides, and fetching it would be triggered only when the actual need arises. In the latter example, this would be when the physician examines the patient at the emergency room. Obviously, in this scenario an additional undue delay is posed since the physician has to wait until the sought data arrives, e.g. in order to ascertain whether the patient is allergic to the medicament that the physician plans to administer.

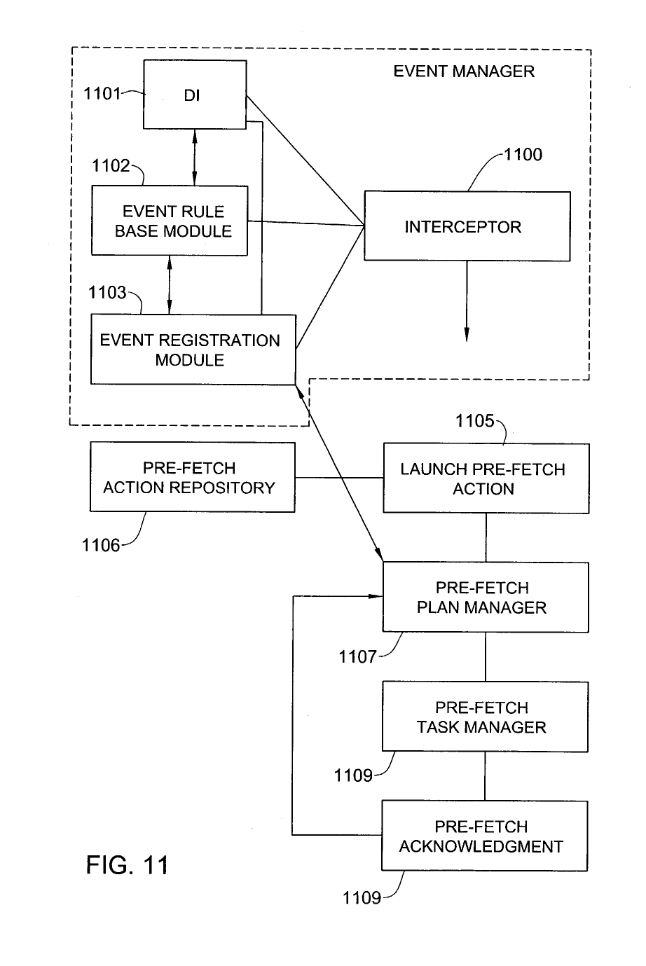

Attention is now drawn to FIG. 11 illustrating a more detailed flow diagram of a pre-fetch architecture and pertinent procedure in accordance with one embodiment of the invention. The invention is not bound by the specific architecture and operational steps depicted in FIG. 11.

As shown, interceptor (1100) is coupled to Demographic index (1101), Event Rule Base (ERB) (1102) and to Event Registration Module (ERM) (1103), all of which form part of event manager module 1002 of FIG. 10.

The ERB serves as a pre-fetch knowledge base for rules and the pertinent action items which govern the pre-fetch procedure. For example, it includes a triggering event such as “a birth of a baby” and the pertinent action items, i.e. what is the pertinent information that is required to pre-fetch in the case that “a baby borne” is triggered. Such an information may include, for example, the medical record of the mother.

The Event Registration Module (ERM) (1103) is a knowledge base which defines in a dynamic fashion the -validation of the rules and the action items of the ERB, based on various criteria. By way of non limiting example, such criteria include:

i. “Customization” of the rules to the given nodes. Thus, if a given hospital has no maternity ward, then obviously rules such as “birth of a baby” event (in the ERB) is disabled for his particular node;

ii. The applicability of the rules for given dates. For example, the Trauma unit in a given hospital is closed for a certain period (say, due to reconstruction or renovation);

iii. Statistics that pertain to the usage and hit rate of rules; for example statistics that pertain to the more (or less) commonly used rules, and statistic that pertain to the hit/miss rate. For instance, for a given rule, how many times (possibly represented as percentage rate) the sought data were really fetched. The latter information may serve for, say, inquiring why for a given rule the sought data is never fetched? Such inquiry may result in modifying or deleting the specified rule;

iv. Temporary database for new rules that are “candidates” for recording in the ERB.

Note that the list of criteria specified above is, by no means, binding and, accordingly, one or more of the criteria may be deleted or modified and/or others may be added, all as required and appropriate, depending upon the particular application.

Note also that the breakdown to ERB and ERM in the manner specified is by no means binding, and accordingly other architectures may be utilized, e.g. a combined knowledge base or different allocation of modules in a knowledge base, all as required and appropriate, depending upon the particular application.

Those versed in the art will readily appreciate that the invention is not bound by a specific structure, type and organization of knowledge base, and accordingly any known, per se, techniques for constructing and using knowledge base are applicable.

Having described the function of the ERB and ERM modules, an operational scenario, in accordance with one embodiment of the invention will now be described. Thus, interceptor 1100 listens to external or internal events and communicates with the ERB and ERM to ascertain whether the so occurred event should trigger pre-fetching of data. For example, consider an external event of arrival of a patient to the hospital after a car accident. The detailed of the patient (say ID number) are fed into the system either manually or in any other known per se manner (say, automatically, by reading the ID card details, in the case that the ID is a smart card capable of broadcasting the ID number and other pertinent details). Next, the ERB and ERM are accessed in order to determine whether any pre-fetch rules apply. For example, it may well be the case that the ERM indicates that such rules are not applicable for this hospital (since, say, the hospital does not employ an Emergency room) and accordingly, the patient should be transferred to a different hospital. If, on the other hand, the so-occurred event is recorded in the ERB and is not overruled by the ERM, then the interceptor fires an event with specified parameters (e.g., in the latter example, say the blood type, previous blood test results, and allergy to medicaments, are the sought data). As specified above, the interceptor can listen also to internal event which by this embodiment originates from the Event Rule Base module 1102. An exemplary internal event is, identify patients who have been subjected to Xray tests. This is an internal event in the sense that no “external data” is required, since the pertinent data of patients and Xray tests performed is already stored in the DI 1101 and therefore readily accessible by the ERB 1102. The listener (1100) can obtain these data through interaction with the demographic index (1101) and the ERB (1102). Having encountered an internal event, the ERB (ERM) are accessed to identify what data (if any) needs to be pre-fetched, similarly to what had been performed when an external event is encountered. Obviously, internal events can be of more complicated nature, such as patients who were subjected to more than 5 Xray tests in the last three months (the test period), but not during the year that precedes the test period. By one embodiment support in more complicated internal events and/or combination of internal and external events can be realized by applying operators to basic events. For example, a first internal “simple” event is “children who suffer from cancer” (which may or may not prescribe pr-fetching of data, all as explained above); a second internal “simple” event is “patients who were subject to Xray test” (again, an event which may or may not prescribe pr-fetching of data, all as explained above). A complex internal event may be composed by “first event AND second event”, signifying “children who suffer from cancer and who were subjected to Xray test”. This complex event may be defined in the ERB 1102, either explicitly or as a formula (e.g. event1 AND event 2, where event1 and event 2 are already defined). The composed event by itself may prescribe pre-fetching of data (relevant to children who suffer from cancer and were subjected to Xray test). Obviously, other complex events may be defined possibly using also other operators such as OR, NOT, COUNT etc. Complex events can be defined by one embodiment using a query language with SQL like expressive power. Note that complex events by themselves (and/or external events) can form part of a definition of more complex events.

By this non-limiting embodiment, the event and parameters are fed to Launch action generator module (1105) which interprets the parameters to actual inquiries of data to fetch and whenever applicable communicates with Pre-fetch Action Repository module (1106). The latter stores standing instructions for specific or group of events. For example, in the case of “birth of baby” event a standing instruction could be send an SMS message to designated addressees (say by providing pop-up menu for feeding in the SMS destination, or accessing database that a priori stored the sought information. Note that the contents of the pre-fetch action repository, may be determined, depending upon the particular application. For example, some or all of the action items in the pre-fetch action repository (1106) may be stored in the ERB and form part of the parameters that are fed to module (1105). Obviously, in the case that all of the data forms part of the so fed parameters, then module (1106) is not required.

Having determined what data is required for fetching, the specified parameters are fed to pre-fetch plan manager 1107 which determine which nodes hold the sought data. The procedure of inquiring the DI, transmitting queries to the designated nodes and receiving replies was described in detail, with reference to non-limiting embodiments and their associated FIGS. 1 to 4.

FIG. 11 further depicts one form of obtaining pre-fetched data, where Pre-Fetch Plan Manager is responsible on the fetching of data at top level, and to this end it employs a pre-fetch task manager (1108) and a pre-fetch acknowledgement module (1109). The task plan “breaks” the plan into specific tasks. For example, if the sought data is “the baby's mother Lab tests”, then the plan manager may break this plan to distinct tasks such as first task “blood tests”, second task urine tests, etc. Each task is controlled by the task manager (1108) which invokes the task by transmitting queries to the designated nodes in the manner described with reference to FIGS. 1 to 4. Acknowledgments (i.e. whether the sought data arrived or not) are monitored by module (1109) which reports on the same to the plan manager (1107). The latter, based on the received acknowledgements, decides whether to activate the next task, etc.

Note also the plan may dynamically change, depending upon the received information. For example, in the case that not sufficient blood test results are available (based on the fetched data in response to the blood test inquiry task), the Manager Plan may invoke a different task, say obtain blood Lab tests of the father of the so borne baby. The various options of the plan may be realized, e.g. in the form of state machine that “covers” the various operational scenarios, all as known per se. Note that the plan manager and task manager, may be employed in a similar fashion for fetching data (in the manner described with reference to FIGS. 1 to 4) and not necessarily only for handling pre-fetching of data (as described with reference to FIGS. 10 and 11).

The invention is, of course, not bound by the specific realization of plan manager and task manager discussed with reference to FIG. 11.

Note also that the pre-fetch procedure may be utilized together with the load balancing procedure described above. For example, in order to pre-fetch data, the load balancing procedure may be employed in order to determine which node or nodes would be the query (i.e. pre-fetch query) processing nodes. Note also that when plan is broken into tasks (for the specific example of FIG. 11), some of the tasks may be processed in different nodes, depending upon the results of the load balancing procedure. Other variants are applicable, all as required and appropriate.

In the method claims that follow, alphabetic characters used to designate claim steps are provided for convenience only and do not imply any particular order of performing the steps.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The invention has been described with a certain degree of particularity, but those versed in the art will readily appreciate that various alterations and modifications may be carried out without departing from the scope of the following claims:

1. A method for a unified management of queries in a distributed environment that includes plurality of nodes interconnected through a communication network, each node is associated with a database that stores information on subjects; the method comprising:
i) in a query initiating node, placing a query in respect of at least one subject;
ii) applying load balancing for determining at least one query processing node, and in the case that a query processing node being different node than the query initiating node, transmitting the query to the query processing node;
iii) determining in the query processing node at least one remote node in the network, if any, such that the database of each one of said remote nodes stores information on at least one of said subjects, and transmitting the query, through said communication network, to said remote nodes;
iv) each one of the remote nodes processing the query, giving rise to respective query results and transmitting the query results to said query processing node;
v) the query processing node merging the query results received from said remote nodes into a complete merged query result; and
vi) displaying at least part of said complete query result.

2. The method according to claim 1, wherein in said (iv), at least one of the remote nodes processing the query in an asynchronous fashion, and wherein the method further includes: receiving acknowledgment from the at least one remote node that the query is pending for processing, thereby obviating the need for a prolonged polling of the nodes.

3. The method according to claim 1, wherein each of the query results in said (iv) is in a form of semi-structured stream, constituting a semi-structured query result, and wherein the query processing node merging the semi-structured query results into a complete semi-structured result.

4. The method according to claim 3, wherein said semi-structured query result and complete semi-structured query result being in an XML form.

5. The method according to claim 1, wherein each query is associated with a unique query id, and wherein the query id is transmitted in said (ii) and (iii), and wherein said (iv) further includes:
identifying the query that is associated with said unique query id and processing the so identified query.

6. The method according to claim 1, further including the following, executed as many times as required: propagating through said network at least one new query and its respective unique query id to at least one designated node.

7. The method according to claim 1, wherein said load balancing in (ii) includes evaluating for the query initiating node a score bases on either or both of context related score and performance related score and obtaining, through said network, a score for other nodes from among said remote nodes; determining the query processing node to be the node with the highest score.

8. The method according to claim 7, wherein said performance related score is based on distinct scores in respect of statistics that pertain to resource availability of the node, statistics that pertain to how many responses per subject per minute were obtained, and statistics that pertain to how many remote vs. local responses were obtained.

9. The method according to claim 8, wherein said performance related score is determined by averaging said distinct scores.

10. The method according to claim 7, wherein said context related score depends on the amount of stored data that meets the so placed query, such that the more the stored data in the database associated with the node the higher the context related score.

11. For use in the method claim 1, (iii) and (v), executed at the query processing node.

12. For use in claim 1, (iv) executed at a remote node.

13. The method according to claim 1, for use in clinical information retrieval system, wherein said subjects being patients and wherein said nodes being distinct resources depositing clinical information.

14. A system for a unified management of queries in a distributed environment that includes plurality of nodes interconnected through a communication network;
a query initiating node configured to receive or place a query in respect of at least one subject; the query initiating node includes processor and communication and is associated with a database having given characteristics; the database stores information on subjects; the node is further associated with demographic index and query catalog; the processor is configured to perform load balancing for determining at least one query processing node, and in the case that a query processing node being different node than the query initiating node, transmitting the query to the query processing node;
the query processing node includes processor and communication and is associated with a database having given characteristics; the database stores information on subjects; the node is further associated with demographic index and query catalog,
the processor and communication being configured to perform the following, including:
placing or receiving a query in respect of at least one subject;
accessing said demographic index and query catalog for determining at least one remote node in the network, if any, such that the database of each one of said nodes stores information on at least one of said subjects and determining a query format that meets the respective data characteristics of the database of each node;
transmitting the query, through said communication network, to each one of the at least one remote nodes;
receiving the query result from said at least one remote nodes in an asynchronous fashion;
merging the query results received from said selected node into a complete merged query result; and
displaying at least part of said complete query result.

15. The system of claim 14, wherein said processor and communication of the query processing node are further configured to receiving acknowledgment from the selected nodes that the query is pending for processing thereby obviating the need for a prolonged polling of the selected node.

16. The system according to claim 14, wherein the query result is in a form of semi-structured stream, constituting a semi-structured query result, and wherein the node merging the semi-structured query results into a complete semi-structured result.

17. The system according to claim 16, wherein said semi-structured query result and complete semi-structured query result being in an XML form.

18. The system according to claim 14 further wherein the processor and communications in said query initiating node are further configured to propagate through said network at least one new query and its respective unique query id to at least one designated node.

19. The system according to claim 14, for use in clinical information retrieval system, wherein said subjects being patients and wherein said nodes being distinct resources depositing clinical information.

20. The system according to claim 14, wherein said load balancing includes evaluating for the query initiating node a score bases on either or both of context related score and performance related score and obtaining, through said network, a score for other nodes from among said remote nodes; determining the query processing node to be the node with the highest score.

21. The system according to claim 20, wherein said performance related score is based on distinct scores in respect of statistics that pertain to resource availability of the node, statistics that pertain to how many responses per subject per minute were obtained, and statistics that pertain to how many remote vs. local responses were obtained.

22. The system according to claim 21, wherein said performance related score is determined by averaging said distinct scores.

23. The system according to claim 20, wherein said context related score depends on the amount of stored data that meets the so placed query, such that the more the stored data in the database associated with the node the higher the context related score.

24. For use in a system for a unified management of queries in a distributed environment that includes plurality of nodes interconnected through a communication network, according to claim 14;
a node that includes processor and communication and is associated with a database having given characteristics; the database stores information on subjects; the node is further associated with demographic index and query catalog,
the processor and communication being configured to perform the steps that include:
receiving a query, through said communication network, from an originating node; and
processing the query in an asynchronous fashion and transmitting the query result to said originating node.

25. The system of claim 24, wherein said processor and communication further comprising:
transmitting acknowledgment to said originating node that the query is pending for processing thereby obviating the need for a prolonged polling of the selected node.

26. The system according to claim 24, wherein the query result is in a form of semi-structured stream, constituting a semi-structured query result.

27. The system according to claim 26, wherein said semi-structured query result and complete semi-structured query result being in an XML form.

28. The system according to claim 24, wherein each query is associated with a unique query id, and wherein the query id is received and further including
identifying in the query catalog the query that is associated with said unique query id and determining a query format that meets the data characteristics of the database of the node and processing the so determined query.

29. The system according to claim 24, wherein said processor and communication are further configured to perform the following as many times as required: receiving through said network at least one new query and its respective unique query id and updating the query catalog.

30. A storage medium storing computer code configured to perform the method steps of claim 1.

31. A method for a unified management of queries in a distributed environment that includes plurality of nodes interconnected through a communication network, each node is associated with a database that stores information on subjects; the method comprising:
i) receiving an occurring event;
ii) analyzing the occurring event and determining information that needs to be pre-fetched, and in response firing a triggering event;
iii) placing a pre-fetch query in respect of at least one subject;
iv) determining at least one remote node in the network, if any, such that the database of each one of said remote nodes stores information on at least one of said subjects, and transmitting the query, through said communication network, to said remote nodes;
v) each one of the remote nodes processing the query, giving rise to respective pre-fetched query results and transmitting the query results to said query processing node;
vi) merging the pre-fetched query results received from said remote nodes into a complete merged query result; and
vii) displaying at least part of said complete pre-fetched query result.

32. The method according to claim 31, wherein said analyzing includes:
identifying the occurring event in a database, giving rise to triggering event, and determine that the triggering event is valid.

33. The method according to claim 31, further comprising fetching supplemental data, whenever required.

34. The method according to claim 33, wherein said fetching supplemental data includes:
viii) placing or receiving a query in respect of at least one subject;
ix) determining at least one remote node in the network, if any, such that the database of each one of said remote nodes stores information on at least one of said subjects, and transmitting the query, through said communication network, to said remote nodes;
x) each one of the remote nodes processing the query, giving rise to respective query results and transmitting the query results to said query processing node;
xi) merging the query results received from said remote nodes into a complete merged query result; and
xii) displaying at least part of said complete query result.

35. The method according to claim 31, wherein said placing a pre-fetched query in (iii) being in a query initiating node, and wherein said query initiating node further applying load balancing for determining at least one query processing node, and in the case that a query processing node being different node than the query initiating node, transmitting the query to the query processing node; the method comprising
iv) determining at least one remote node in the network, if any, such that the database of each one of said remote nodes stores information on at least one of said subjects, and transmitting the query, through said communication network, to said remote nodes;
v) each one of the remote nodes processing the query, giving rise to respective pre-fetched query results and transmitting the query results to said query processing node;
vi) the query processing node merging the pre-fetched query results received from said remote nodes into a complete merged query result; and
vii) displaying at least part of said complete pre-fetched query result.

36. A system for a unified management of queries in a distributed environment that includes plurality of nodes interconnected through a communication network;
a node includes processor, communication and associated database having given characteristics; the database stores information on subjects; the database includes demographic index and query catalog;
the processor and communication and associated database being configured to perform the following, including:
receiving an occurring event, analyzing the occurring event and determining information that needs to be pre-fetched, and in response firing a triggering event;
placing a pre-fetch query in respect of at least one subject;
accessing said demographic index and query catalog for determining at least one remote node in the network, if any, such that the database of each one of said nodes stores information on at least one of said subjects and determining a query format of said pre-fetch query that meets the respective data characteristics of the database of each node;
transmitting the query, through said communication network, to said remote nodes;
receiving pre-fetched query result from said at least one remote nodes in an asynchronous fashion;
merging the pre-fetched query results received from said selected node into a complete merged query result; and
displaying at least part of said complete pre-fetched query result.

37. The system according to claim 36, wherein said database further includes Event Rule Base module for storing pre-fetch related rules and Event registration module for determining the validity of said rules.

38. The method according to claim 31 wherein said occurring event being at least one from the group that includes: an internal event, an external event, a complex event that depends on at least one internal event, a complex event that depends on at least one external event, and a complex event that depends on at least one other complex event.

39. The system according to claim 36 wherein said occurring event being at least one from the group that includes: an internal event, an external event, a complex event that depends on at least one internal event, a complex event that depends on at least one external event, and a complex event that depends on at least one other complex event.
